(19) United States
(12) Patent Application Publication
(10) Pub. No.: US 2018/0258003 A1
(43) Pub. Date: Sep. 13, 2018

(54) Method for Remodelling Surface of Granular Urea

(71) Applicant: SHANDONG MOITH ECOLOGICAL FERTILIZER CO., LTD., Shandong (CN)

(72) Inventor: Chenghu Zhong, Hefei (CN)

(73) Assignee: SHANDONG MOITH ECOLOGICAL FERTILIZER CO., LTD.

(21) Appl. No.: 15/980,681

(22) Filed: May 15, 2018

Related U.S. Application Data
(63) Continuation-in-part of application No. 15/095,005, filed on Apr. 8, 2016, now abandoned.

(51) Int. Cl. C05C 9/00; C05C 9/02; C05G 3/00; B05D 1/02; B05D 3/02

(52) U.S. Cl. CPC C05C 9/005; C05C 9/02; B05D 3/0218; B05D 1/02; C05G 3/0029

(57) ABSTRACT

A method for remodelling granular urea surface, which belongs to the field of resin coated urea manufacturing technology, includes steps of: firstly sending the granular urea with a temperature of 20-80° C. into a drum comprising a shoveling board for rolling in a clockwise or counterclockwise direction; adding reconstituted liquid; dissolving convexes which like peaks and provided on surfaces of granular urea into a reconstituted liquid under a combined effect of mechanical forces and water in the reconstituted liquid; and introducing dry and hot wind, in such a manner that the urea dissolved in the recycled liquid is filled onto concaves of surfaces of the granular urea; wherein after drying is terminated, the granular urea becomes smooth and rounded; uneven surfaces of the convexes which are in a shape of peaks disappear; and the surfaces of the granular urea are shiny and show a mirror effect.

### CROSS REFERENCE OF RELATED APPLICATION

This is a Continuation-In-Parts application of an application having an application Ser. No. 15/095,005 filed on Apr. 8, 2016.

### BACKGROUND OF THE PRESENT INVENTION

### Field of Invention

The present invention relates to a method for remodelling granular urea surface, which belongs to the field of resin coated urea manufacturing technology.

### Description of Related Arts

Since chemical fertilizer is a source of nutrients for crop growth, the controlled release of nutrients in chemical fertilizer is very important. In recent years, new types of fertilizer have caused wide public concern. Compared with conventional fertilizer, slow/controlled release fertilizer is capable of automatically adjusting nutrient release based on the requirements of crops, i.e. the slow/controlled release fertilizer will neither release insufficiently and result in plant nutrient deficiency, nor release excessive nutrient and result in nutrient loss and waste, which significantly improves fertilizer utilization efficiency and reduces the amount of fertilizer used; it also has the advantages of reducing the frequency of fertilization, saving labor, reducing crop diseases and pests, and improving the quality of agricultural products etc. Thus, the slow/controlled release fertilizer has become one of the key fertilizers promoted by the Ministry of Agriculture.

The slow/controlled release fertilizers mainly use traditional fertilizers as core fertilizers, and the outer layer is coated with a biodegradable organic coating agent. The granular urea purchased is often an ordinary product used in agriculture. The surface of the granular urea has a rough surface and uneven surface. When the membrane is coated, it may cause incomplete and uneven coating, leading to a large increase in initial nutrient release rate. Nutrient release is unstable. Repeated coating is needed. For the membrane coating technology, the coating material is wasted, the cost of the coating is increased, and the production efficiency is reduced. Therefore, if the surface of the granular urea is smooth and rounded, the uniformity and completeness of the coating of the resin coating material on the surface of the large-particle urea can be improved, so that the coating rate and production cost can be reduced, the initial release rate of the resin-coated urea can be reduced; the quality and appearance of resin-coated urea is improved and the competitiveness of the market is enhanced.

CN 101659583B discloses a post-treatment method of granular fertilizer. After the granular fertilizer is placed in a rotating drum, the urea and/or ammonium nitrate plus binder coating liquid is coated on the surface of the granular fertilizer and dried. Through the treatment, the roundness and surface smoothness of the fertilizer can be used to improve the nutrient release of the membrane controlled-release fertilizer. However, the solvent of the coating solution is water, the solute is urea and/or ammonium nitrate, the mass concentration of urea and/or ammonium nitrate is 30%-80%, and at the same time, dry hot air is blown to evaporate water quickly, and the solute rapidly crystallizes to be cured on the surface of urea. The treatment process is that the solute urea and/or ammonium nitrate is solidified to fill the concave surface of the fertilizer granules, gradually reaching smooth and round, and the coating liquid is almost completely saturated or supersaturated. The whole process is solute drying. The process of crystallization. The process does not have water to dissolve the large urea surface like mountain peaks, only has the solute drying process. In order to achieve the identical effect, a larger amount of solution is required, which increases the production cost, and reduces the production efficiency. In addition, since the dissolution process of urea and ammonium nitrate is an endothermic process and requires heating, especially when the above-mentioned high-concentration liquid coating solution is prepared, heating is required to increase the solubility. In winter, heating is more necessary, and it is required to prepare a dissolved tank with heating, and energy consumption high.

A Chinese patent application with a publication number of CN 102584494A discloses a method for preparing in-situ coated controlled-release fertilizer of urea sustained-release granule fertilizer. Urea granules are put into a fluidized bed coating machine, and the surface is sprayed with formaldehyde solution, formaldehyde and urea under the conditions of acidity and heating. The mixed solution forms a uniform coating to prepare the coated slow-release fertilizer. The principle is that the chemical reaction between urea and formaldehyde reacts on the surface of urea to form a sustained-release layer of urea formaldehyde, not as a pretreatment process for the slow and controlled release fertilizer core, but as a slow release fertilizer for the direct preparation of a urea formaldehyde envelope. The method, but the urea-formaldehyde coated slow-release fertilizer, the sustained-release effect is not satisfactory, the nutrient release performance is not stable, and does not have the “S” type release characteristics in accordance with the growth characteristics of plants.

### SUMMARY OF THE PRESENT INVENTION

The object of the present invention is to provide a method for remodeling a surface of granular urea. After the granular urea is treated by the method of the present invention, the surface of the granular urea is smooth and round, the uneven surface of the peak-shaped convex disappears and the surface is shiny and shows a mirror effect. Thus, the uniformity and integrity of the membrane of the resin-coated urea membrane are improved, the defect of the membrane is reduced, the initial release rate is reduced. After coating, the release period is more accurate and controllable. Furthermore, the coating cost is saved due to the reduced coating rate and production efficiency is improved.

An object of the present invention is to provide a method for remodelling a surface of granular urea, comprising steps of:

(a) removing peaks

dissolving convexes which like peaks and provided on surfaces of granular urea into a reconstituted liquid under a combined effect of mechanical forces and water in the reconstituted liquid;

(b) filling concaves

introducing dry and hot wind, in such a manner that the urea dissolved in the recycled liquid is filled onto concaves of surfaces of the granular urea; wherein after drying is terminated, the granular urea becomes smooth and rounded; uneven surfaces of the convexes which are in a shape of peaks disappear; the surfaces of the granular urea are shiny and show a mirror effect.

When coating the urea treated by the method for remodeling the surface mentioned above, under a condition with a coating rate of 1.8%-2.3%, the initial release rate is less than 1%, a release period reaches 50-60 days, and a nitrogen content reaches 45.3%-45.6%, greatly reducing the cost of coating.

Furthermore, a specific solution of the step (a) comprises:

heating the granular urea to 20-80° C., so as to enhance a solubility of the granular urea in water; and then sending the granular urea into a drum comprising a shoveling board for rolling in a clockwise or counterclockwise direction; wherein a rotational speed is at a range of 1-10 revolution per minute, a rotational time is at a range of 3-10 minutes until all urea granules in the drum are in a uniform tumbling state;

then, enhancing the rotational speed of the drum to 10-30 revolutions per minute, slowly and evenly spraying the reconstituted liquid on surfaces of the granular urea; moments friction between particles of the granular urea and the drum, particles and shoveling board, particles and particles drives the convexes which like peaks on the surfaces of the granular urea to dissolve under a combined action of mechanical forces and water of the reconstituted liquid; waiting for 3-15 minutes; wherein no hot wind is allowed during the process.

Furthermore, the reconstituted liquid is added until, calculated by the granular urea, a mass fraction of the granular urea is at a range of 0.1-4%, and preferably 0.5-2%.

Furthermore, the reconstituted liquid is water.

Furthermore, the reconstituted liquid is unsaturated solution containing water.

Furthermore, the unsaturated solution is urea solution, wherein a mass percent of the urea is at a range of 0.001-10%.

Furthermore, the unsaturated solution is formaldehyde solution, wherein a mass percent of the urea is at a range of 0.01-5.0%.

Furthermore, the unsaturated solution is urea formaldehyde aqueous solution, wherein a mass percent of the urea formaldehyde aqueous solution is at a range of 11-30%.

The method for remodelling the surface of the granular urea, as recited in claim 2, wherein the reconstituted liquid is added in one time or 2-5 times.

Furthermore, a diameter of the drum is at a range of 0.5-10 m, preferably 1-8 m, more preferably 2-7 m, and most preferably 3-5 m; and a feed height from a bottom of the drum of granule urea is at a range of 0.1-1 m, preferably 0.3-0.7 m and more preferably 0.4-0.6 m.

When granular urea is added to the reconstituted liquid, since the solubility of urea at 20-80° C. is large, the recycled liquid will quickly dissolve and soften the surface of granular urea. The granular at the bottom of the drum due to the high-speed rotation of the roller with the shoveling board urea is compressed and rubbed by the plate and the upper granules of urea, the softened urea surface has a peak-like raised portion will be dissolved first in the recycled liquid and exposed below the peak. The peak-like convexes are once again subjected to the softening effect of the remodeling liquid, and is again subjected to squeezing, rubbing, and being dissolved in the reconstituted liquid until the solution is saturated. The duration of the entire process is 3-15 minutes, and the drum is rotated at a high speed and rubs. In the process of treating, hot air cannot be introduced to prevent the hot air from taking away water and affecting the treatment effect. This process is a process in which the remodeling liquid dissolves the mountain-like projections on the surfaces of granular urea.

Furthermore, a specific solution of the step (b) is:

adjusting a rotational speed of the drum to 1-10 revolution per minute to avoid a high speed; wherein high-speed frictions and impacts among the granular urea, and between the granular urea and the plate of the drum cause formation of urea powder, and new surfaces with convexes and concaves are formed; introducing dry and hot wind to dry water on the surfaces of the granular urea; in such a manner that the urea which is dissolved in the reconstituted liquid is crystallized to fill the concaves on the surfaces of the granular urea; controlling a final moisture content of the granular urea to be less than 0.5%; wherein the granular urea becomes smooth and rounded; uneven surfaces of the convexes which are in a shape of peaks disappear; the surfaces of the granular urea are shiny and show a mirror effect.

The method for remodeling the surface of the granular urea, as recited in claim 12, wherein the hot wind introduced for drying has a temperature at a range of 100−200° C.; for one ton of granular urea, a ventilation rate is at a range of 50-1000 cubic meters per minute; a drying time is at a range of 5-40 minutes.

Wherein, the mirror effect means that when the light source is irradiated to the surface of the granular urea after the surface remodeling treatment, the granular urea is bright, and the surface of the resin urea formed by the granular urea by the coating is also bright when irradiated by the light source.

Compared with the conventional art, the present invention has the following advantages.

1. The process of unsaturated water reconstituted liquid to dissolve the peak-like convexes of the surface of large urea. Use the water in the reconstructed liquid to dissolve the peak-like convexes of urea surface, fully dissolve and then dry. The surface of the granular urea achieves better results, and the amount of reconstructed liquid added is only 0.2%-4%, preferably 0.5%-2%, but better treatment effect is achieved, achieving coating rate of 1.8%-2.3. The ultra-low coating rate of 1.8-2.3% greatly reduces the coating cost.

2. The added reconstituted liquid is water or an unsaturated unsaturated aqueous solution, especially water, which does not require special prepared solution, does not require heating, is simple and has low cost.

3. The release effect of the surface of the peak-like projections on the membrane is reduced, and the release stability of the membrane is improved. The difference in the release period between different PCU batches is controlled within 10%, which improves the quality of the PCU.

These and other objectives, features, and advantages of the present invention will become apparent from the following detailed description, the accompanying drawings, and the appended claims.

### DETAILED DESCRIPTION OF THE PREFERRED EMBODIMENT

In order to make the objectives, technical solutions, and advantages of the present invention clearer and more comprehensible, the following further describes the present invention in detail combining with the embodiments. It should be understood that the specific embodiments described herein are only used to explain the present invention and are not intended to limit the present invention. In addition, the technical features involved in the various embodiments of the present invention described below can be combined with each other as long as they do not constitute a conflict with each other.

### Example 1 Reconstituted Liquid is Water

Weigh one ton of granular urea having a diameter at a range of 2.00-4.75 mm supplied by Jiangsu Shuangduo Company, heat to 40° C., and put into a drum with a diameter of 5 meters; wherein the drum has nozzles and a shoveling board system consists of 6 groups of inverted “A” shaped shoveling boards; adjust a rotation speed of the drum to 6 revolutions per minute, so that the urea rotates clockwise in the drum and rotates for 7 minutes; all urea particles in the drum are in a uniform rolling state; increase a speed of the drum to 18 revolutions per minute, and stop introducing hot air; add 10 kg of water in one time by a metering pump; atomizing the water and spraying the water onto surfaces of the granular urea by a nozzle, in such a manner that surfaces of the granular urea are quickly wetted and softened; and meanwhile particles of the granular urea perform friction motions with the drum and the shoveling board, in such a manner that convexes which like peaks on surfaces of the granular urea are dissolved in water under a combined action of mechanical forces and water; last a treatment process for 10 minutes until uneven surfaces of the convexes which like peaks disappear; then adjust a rotational speed of the drum to 6 revolutions per minute; introduce dry and hot wind with a temperature of 120° C.; wherein an air volume is 400 m³/min; a moisture content of the granular urea after a surface treatment is 0.5%; a percentage content of the water in the granular urea is 1.0%; a drying time is 25 minutes; wherein the granular urea becomes smooth and rounded; uneven surfaces of the convexes which are in a shape of peaks disappears; the surfaces of the granular urea are shiny and showing a mirror effect.

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 3 times until the coating process is completed; and cool to obtain a resin-coated urea.

A coating rate of the resin-coated urea in the example 1 is 2.0%.

### Example 2 Reconstituted Liquid is Urea Solution

1. Preparing the reconstituted liquid: weigh 1.0 kg of urea to be added to 19 kg of water, fully stir for dissolving to obtain aqueous urea solution with a mass fraction of 5.0%.

2. Weigh one ton of granular urea having a diameter at a range of 2.00-4.75 mm supplied by Jiangsu Shuangduo Company, heat it to 40° C., and put it into a drum with a diameter of 5 meters; wherein the drum has nozzles and a shoveling board system consists of 6 groups of inverted “A” shaped shoveling boards; adjust a rotation speed of the drum to 9 revolutions per minute, so that the urea rotates clockwise in the drum and rotates for 5 minutes; all urea particles in the drum are in a uniform rolling state; increase a speed of the drum to 24 revolutions per minute, and stop introducing hot air; add 10 kg of the aqueous urea solution in one time by a metering pump; atomizing the water and spraying the unsaturated aqueous urea solution onto surfaces of the granular urea by a nozzle, in such a manner that surfaces of the granular urea are quickly wetted and softened; and meanwhile particles of the granular urea perform friction motions with the drum and the shoveling board, in such a manner that convexes which like peaks on surfaces of the granular urea are dissolved in the unsaturated aqueous urea solution under a combined action of mechanical forces and water; last a treatment process for 12 minutes until uneven surfaces of the convexes which like peaks disappear; then adjust a rotational speed of the drum to 9 revolutions per minute; introduce dry and hot wind with a temperature of 120° C.; wherein an air volume is 350 m³/min; a moisture content of the granular urea after a surface treatment is 0.5%; a percentage content of the water in the granular urea is 0.95%; a drying time is 30 minutes; wherein the granular urea becomes smooth and rounded; uneven surfaces of the convexes which are in a shape of peaks disappears; the surfaces of the granular urea are shiny and showing a mirror effect.

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 3 times until the coating process is completed; and cool to obtain a resin-coated urea.

A coating rate of the resin-coated urea in the example 1 is 2.0%.

### Example 3 Reconstituted Liquid is Aqueous Formaldehyde Solution

1. Preparation of reconstituted liquid: weigh 1.12 g of formaldehyde with a mass concentration of 37%, add the formaldehyde to 18.88 kg of water, stir and dissolve thoroughly to obtain aqueous formaldehyde solution, wherein a mass fraction of formaldehyde in the aqueous formaldehyde solution obtained is 2%.

2. Weigh one ton of granular urea having a diameter at a range of 2.00-4.75 mm supplied by Jiangsu Shuangduo Company, heat to 40° C., and put into a drum with a diameter of 5 meters; wherein the drum has nozzles and a shoveling boards system consists of 6 groups of inverted “A” shaped shoveling boards; adjust a rotation speed of the drum to 8 revolutions per minute, so that the urea rotates clockwise in the drum and rotates for 6 minutes; all urea particles in the drum are in a uniform rolling state; increase a speed of the drum to 22 revolutions per minute, and stop introducing hot air; add 10 kg of the aqueous formaldehyde solution in one time by a metering pump; atomizing the unsaturated aqueous formaldehyde solution and spraying the unsaturated aqueous formaldehyde solution onto surfaces of the granular urea by a nozzle, in such a manner that surfaces of the granular urea are quickly wetted and softened; and meanwhile particles of the granular urea perform friction motions with the drum and the shoveling board, in such a manner that convexes which like peaks on surfaces of the granular urea are dissolved in the unsaturated aqueous formaldehyde solution under a combined action of mechanical forces and water; last a treatment process for 11 minutes until uneven surfaces of the convexes which like peaks disappear; then adjust a rotational speed of the drum to 8 revolutions per minute; introduce dry and hot wind with a temperature of 130° C.; wherein an air volume is 200 m³/min; a moisture content of the granular urea after a surface treatment is 0.5%; a percentage content of the water in the granular urea is 0.98%; a drying time is 40 minutes; wherein the granular urea becomes smooth and rounded; uneven surfaces of the convexes which are in a shape of peaks disappears; the surfaces of the granular urea are shiny and showing a mirror effect.

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 3 times until the coating process is completed; and cool to obtain a resin-coated urea.

A coating rate of the resin-coated urea in the example 1 is 2.0%.

### Example 4 Reconstituted Liquid is Urea Formaldehyde Solution

1. Weigh 2.4 g of urea formaldehyde, add the urea formaldehyde to 17.6 kg of water, stir and dissolve thoroughly to obtain urea formaldehyde solution, wherein a mass fraction of the urea formaldehyde in the urea formaldehyde solution obtained is 12%.

2. Weigh one ton of granular urea having a diameter at a range of 2.00-4.75 mm supplied by Jiangsu Shuangduo Company, heat it to 40° C., and put it into a drum with a diameter of 5 meters. The roller has nozzles and a shoveling boards system consists of 6 groups of inverted “A” shaped shoveling boards; adjust a rotation speed of the drum to 8 revolutions per minute, so that the urea rotates clockwise in the drum and rotates for 6 minutes; all urea particles in the drum are in a uniform rolling state; increase a speed of the drum to 20 revolutions per minute, and stop introducing hot air; add 10 kg of urea formaldehyde solution in one time by a metering pump; atomizing the unsaturated urea formaldehyde solution and spraying the unsaturated urea formaldehyde solution onto surfaces of the granular urea by a nozzle, in such a manner that surfaces of the granular urea are quickly wetted and softened; and meanwhile particles of the granular urea perform friction motions with the drum and the shoveling board, in such a manner that convexes which like peaks on surfaces of the granular urea are dissolved in the unsaturated urea formaldehyde solution under a combined action of mechanical forces and water; last a treatment process for 14 minutes until uneven surfaces of the convexes which like peaks disappear; then adjust a rotational speed of the drum to 8 revolutions per minute; introduce dry and hot wind with a temperature of 110° C.; wherein an air volume is 400 m³/min; a moisture content of the granular urea after a surface treatment is 0.5%; a percentage content of the water in the granular urea is 0.88%; a drying time is 32 minutes; wherein the granular urea becomes smooth and rounded; uneven surfaces of the convexes which are in a shape of peaks disappears; the surfaces of the granular urea are shiny and showing a mirror effect.

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 3 times until the coating process is completed; and cool to obtain a resin-coated urea.

A coating rate of the resin-coated urea in the example 1 is 2.0%.

### Comparative Example 1

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 3 times until the coating process is completed; and cool to obtain a resin-coated urea.

A coating rate of the resin-coated urea in the example 1 is 2.0%.

### Comparative Example 2

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 4 times until the coating process is completed; and cool to obtain a resin-coated urea.

A coating rate of the resin-coated urea in the example 1 is 2.6%.

### Comparative Example 3

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating process mentioned above for 5 times until the coating process is completed; and cool to obtain a resin-coated urea.

A coating rate of the resin-coated urea in the example 1 is 3.4%.

### Comparative Example 4

3. Preparation of Resin Coated Urea

Weigh 1 ton of granular urea treated by surface remodeling, heat to 65° C. in a coating machine, molten liquid paraffin with a mass percentage of 0.2% and a melting point of 60 degrees is added, and prepared coating agent of polyurethane is fed into the coating machine with a mass fraction of 0.6% in a total quality of the core fertilizer; continuously mix the coating agent with moving granular urea to evenly distribute the coating agent to surfaces of the granular urea, wherein after 5 minutes, the coating agent of the polyurethane is solidified on the surfaces of the granular urea; repeat coating it) process mentioned above for 6 times until the coating process is completed; and cool to obtain a resin-coated urea.

A coating rate of the resin-coated urea in the example 1 is 4.0%.

TABLE 1
Release performance data of the resin-coated urea obtained after surface
treatment of 1 ton of urea in each example and the resin-coated urea
obtained from 1 ton of untreated urea in each comparative example

| Experimental | Coating | Nitrogen | Initial release | Release period |
|---|---|---|---|---|
| group | rate | content | rate (%) | (day) |
| Example 1 | 2.0% | 45.5% | 0.34 | 63 |
| Example 2 | 2.0% | 45.5% | 0.56 | 57 |
| Example 3 | 2.0% | 45.5% | 0.63 | 61 |
| Example 4 | 2.0% | 45.5% | 0.82 | 58 |
| Comparative | 2.0% | 45.5% | 43.23 | 7 |
| example 1 | | | | |
| Comparative | 2.6% | 45.2% | 33.15 | 14 |
| example 2 | | | | |
| Comparative | 3.4% | 44.8% | 22.76 | 21 |
| example 3 | | | | |
| Comparative | 4.0% | 44.6% | 10.22 | 34 |
| example 4 | | | | |

From the above table, it can be seen that compared with the resin-coated urea obtained without remodeling the surface of the granular urea, the resin-coated urea prepared after treating the surface of the granular urea by the method for remodeling granular urea of the present invention effectively decreases the initial release rate and increases the release period under an identical condition of low coating rate; when the coating rate of the resin-coated urea granular resin without surface treating is increased, the release performance still has obvious advantages and has a good application value.

In summary, since the surface of the granular urea after the surface remodeling of the present invention is smoother and more rounded, coating the urea subjected to the surface remodeling treatment is capable of improving the uniformity and integrity of the membrane of the resin-coated urea, reducing the blemishes of the membrane, and increasing the stability of the membrane release, so as to reduce the initial release rate and prolong the release period simultaneously.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for remodeling a surface of granular urea, comprising steps of:
(a) removing peaks
dissolving convexes which like peaks and provided on surfaces of granular urea into a reconstituted liquid under a combined effect of mechanical forces and water in the reconstituted liquid;
(b) filling concaves
introducing dry and hot wind, in such a manner that the urea dissolved in the recycled liquid is filled onto concaves of surfaces of the granular urea; wherein after drying is terminated, the granular urea becomes smooth and rounded; uneven surfaces of the convexes which are in a shape of peaks disappear; the surfaces of the granular urea are shiny and show a mirror effect.

2. The method for remodelling the surface of the granular urea, as recited in claim 1, wherein a specific solution of the step (a) comprising:
heating the granular urea to 20-80° C., so as to enhance a solubility of the granular urea in water; and then sending the granular urea into a drum comprising a shoveling board for rolling in a clockwise or counterclockwise direction; wherein a rotational speed is at a range of 1-10 revolution per minute, a rotational time is at a range of 3-10 minutes;
then, enhancing the rotational speed of the drum to 10-30 revolutions per minute, slowly and evenly spraying the reconstituted liquid on surfaces of the granular urea; moments friction between particles of the granular urea and the drum, particles and shoveling board, particles and particles drives the convexes which like peaks on the surfaces of the granular urea to dissolve under a combined action of mechanical forces and water of the reconstituted liquid; waiting for 3-15 minutes; wherein no hot air is allowed during the process.

3. The method for remodelling the surface of the granular urea, as recited in claim 2, wherein a mass fraction of the coating solution, on dry basis, in the granular urea is at a range of 0.1-4%.

4. The method for remodelling the surface of the granular urea, as recited in claim 3, wherein a mass fraction of the coating solution, on dry basis, in the granular urea is at a range of 0.5%-2%.

5. The method for remodelling the surface of the granular urea, as recited in claim 1, wherein the reconstituted liquid is water.

6. The method for remodelling the surface of the granular urea, as recited in claim 1, wherein the reconstituted liquid is unsaturated solution containing water.

7. The method for remodelling the surface of the granular urea, as recited in claim 6, wherein the unsaturated solution is urea solution, wherein a mass percent of the urea is at a range of 0.001-10%.

8. The method for remodelling the surface of the granular urea, as recited in claim 6, wherein the unsaturated solution is formaldehyde solution, wherein a mass percent of the urea is at a range of 0.01-5.0%.

9. The method for remodelling the surface of the granular urea, as recited in claim 6, wherein the unsaturated solution is urea formaldehyde aqueous solution, wherein a mass percent of the urea formaldehyde aqueous solution is at a range of 11-30%.

10. The method for remodelling the surface of the granular urea, as recited in claim 2, wherein the reconstituted liquid is added in one time or 2-5 times.

11. The method for remodelling the surface of the granular urea, as recited in claim 2, wherein a diameter of the drum is at a range of 0.5-10 m; and a feed height from a bottom of the drum of granule urea is at a range of 0.1-1 m.

12. The method for remodelling the surface of the granular urea, as recited in claim 1, wherein a specific solution of the step (b) is:
adjusting a rotational speed of the drum to 1-10 revolution per minute to avoid a high speed; wherein high-speed frictions and impacts among the granular urea, and between the granular urea and the plate of the drum cause formation of urea powder, and new surfaces with convexes and concaves are formed; introducing dry and hot wind to dry water on the surfaces of the granular urea; in such a manner that the urea which is dissolved in the reconstituted liquid is crystallized to fill the concaves on the surfaces of the granular urea; controlling a final moisture content of the granular urea to be less than 0.5%; wherein the granular urea becomes smooth and rounded; uneven surfaces of the convexes which are in a shape of peaks disappear; the surfaces of the granular urea are shiny and show a mirror effect.

13. The method for remodelling the surface of the granular urea, as recited in claim 12, wherein the hot wind introduced for drying has a temperature at a range of 100-200° C.; for one ton of granular urea, a ventilation rate is at a range of 50-1000 cubic meters per minute; a drying time is at a range of 5-40 minutes.
